(19) United States
(12) Patent Application Publication
(10) Pub. No.: US 2009/0099957 A1
(43) Pub. Date: Apr. 16, 2009

(54) METHOD OF TRANSFERRING MORTGAGES AND LOANS

(76) Inventors: Ashwin Abhyankar, Simi Valley, CA (US); Deepa R. Prahalad, Simi Valley, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/870,377

(22) Filed: Oct. 10, 2007

(51) Int. Cl. G06Q 40/00

(52) U.S. Cl. 705/38

(57) ABSTRACT

Embodiments of the present invention relate loan agreements, in which a second security may be substituted for an initial security. The substitution may be contingent upon specific characteristics, related to, for example, the second security, the outstanding loan, the initial loan, or the lender.

### BACKGROUND OF THE INVENTION

1. Field of the Invention

Embodiments of the present invention relate loan agreements, in which a second security may be substituted for an initial security. The substitution may be contingent upon specific characteristics, related to, for example, the second security, the outstanding loan, the initial loan, or the lender.

2. Description of the Related Art

Loans are frequently taken out for the purpose of purchasing one or more specific assets. For example, an individual may receive a title loan to purchase an automobile, a mortgage loan to purchase property (e.g., a house), or a student loan to pay for tuition. Typically, a lender gives a borrower an amount of money. The borrower then returns the amount, usually in addition to an interest. The borrower can provide a plurality of payments until the amount is returned.

Loans can be categorized as secured and unsecured. A secured loan indicates a security or collateral that can be repossessed by the lender in the case that the borrower does not follow conditions of the loan agreement. In some instances, the security can include the one or more assets that were at least partially purchased using the loan amount. For example, for mortgage loans, lenders typically receive a lien on the property's title. An unsecured loan does not include a security. For example, credit card debt is typically an example of an unsecured loan. Unsecured loans may require a specific credit score or a co-signer in order to reduce the risk to the lender.

### SUMMARY OF THE INVENTION

In some embodiments, a method of producing a loan agreement defining loan obligations between a borrower and a lender is provided, wherein the method includes determining a loan amount to be advanced by the lender to the borrower; determining an interest rate and payment period for the repayment of the loan amount; and producing a loan agreement for consideration of the borrower and the lender. The loan agreement may include initial loan terms that obligates the lender to provide the borrower with the loan amount in exchange for the borrower providing periodic payments at the payment periods and including the interest rate to the lender. The loan agreement may identify a security including a first asset for repayment of the loan amount. The loan agreement may indicate conditions in which the lender is obligated to abide by the initial loan terms or modified loan terms upon the borrower's decision to substitute a second asset as security for repayment of the loan amount in place of the first asset. The conditions may include a borrower risk variable. The borrower risk variable may include one or more of a credit score, a FICO score, a level of financial documentation, a type of financial documentation, an income-to-expense ratio, a predicted income-to-expense ratio, a type of loan, an income, a predicted income, and an age. The conditions may include an expected security value variable. The expected security value variable may include one or more of an asset value, a demand of an asset, a supply of an asset, and a liquidity of an asset. The conditions may include an outstanding debt value.

The loan agreement may indicate conditions in which the lender is obligated to abide by modified loan terms upon the borrower's decision to substitute a second asset as security for repayment of the loan amount in place of the first asset, wherein the conditions may include a decrease in a borrower risk versus expected security value variable, and wherein the modified loan terms include the initial loan terms modified to be more beneficial to the borrower. The modified loan terms may include one or more of a lower interest rate as compared to that of the initial loan terms, a lower coupon rate as compared to that of the initial loan terms, and a longer grace period as compared to that of the initial loan terms. The loan agreement may indicate conditions in which the lender is obligated to abide by modified loan terms upon the borrower's decision to substitute a second asset as security for repayment of the loan amount in place of the first asset, wherein the conditions may include an increase in a borrower risk versus expected security value variable, and wherein the modified loan agreement terms include the initial loan terms modified to be punitive to the borrower. The loan agreement may indicate conditions in which the lender is obligated to abide by the initial loan terms upon the borrower's decision to substitute a second asset as security for repayment of the loan amount in place of the first asset, and wherein the conditions may include substantially no change or a decrease in a borrower risk versus expected security value variable.

The loan agreement may include one or more of an auto loan agreement, a home loan agreement, a student loan agreement, a credit card agreement, and a corporate debt agreement. The loan agreement may include a mortgage loan agreement and the first asset may include a first real estate property. The second asset may include a second real estate property. The first asset may include a first motor vehicle and the second asset may include a second motor vehicle. The loan agreement may include one or more loan types selected from an auto loan agreement, a home loan agreement, a student loan agreement, a credit card agreement, and a corporate debt agreement. The substitution of a second asset as security for repayment of the loan amount in place of the first asset may include a change in the type of the loan. The interest rate may include either a fixed or a variable interest rate. The conditions may include that the current or predicted value of the second asset must be larger than the outstanding debt associated with the loan. The conditions may include that the second asset be a similar type of asset as the first asset. The loan agreement may further indicate additional conditions and additional loan terms for which the lender is obligated to provide the borrower with an additional loan amount. The additional loan terms may include the initial loan terms.

In some embodiments, a computer program is provided, wherein the program includes instructions stored on a computer readable medium for accepting a first input of an amount of a loan secured by a first asset; accepting a second input related to the risk of securing the loan with a second asset; generating at least one indicator of risk of securing the loan with the second asset for the loan amount; and outputting the at least one indicator of risk.

The second input may include the current or predicted value of the second asset. The generating at least one indicator may include determining whether the current or predicted value of the second asset exceeds an outstanding loan amount. The second input may include one or more of a variable related to a credit score, a FICO score, a level of financial documentation, a type of financial documentation, an income-to-expense ratio, a predicted income-to-expense ratio, a type of loan, an income, a predicted income, and an age. The first input may include an initial loan amount and/or an outstanding loan amount.

In some embodiments, a method for providing a mortgage loan is provided, wherein the method includes providing a loan amount to a borrower in exchange for the agreement of repayment of the loan amount and an interest by the borrower to the loan provider, wherein the repayment may include providing periodic payments of specified amounts and at specified times; securing an interest in a first property as security for the repayment; and substituting a second property for the first property as the security under at least some specified conditions. The method may further include allowing the borrower to sell the first property before the borrower has repaid the loan amount and the interest under the at least some specified conditions. The method may further include changing one or more loan terms upon substitution of the second property for the first property as the security.

In some embodiments, a method for producing a loan agreement defining loan obligations between a borrower and a lender is provided, wherein the method includes determining first loan terms including loan characteristics that are not changeable during the loan term; determining second loan terms including collateral characteristics sufficient for at least partially replacing a collateral; and producing a loan agreement for consideration of the borrower and the lender including the first loan terms and the second loan terms. The first loan terms may include an interest rate, payment periods, and/or an initial collateral. The method may further include determining third loan terms including loan characteristics that are changeable upon the at least partially replacing a collateral.

### BRIEF DESCRIPTION OF THE DRAWINGS

FIG. 1 shows process 100 for producing a loan agreement.

FIG. 2 shows components of a loan agreement.

FIG. 3 shows a process 300 for indicating risk of securing a loan with a substituted asset.

FIG. 4 shows one process 400 for providing a mortgage loan.

FIG. 5 shows one process 500 for producing a loan agreement.

FIG. 6 shows an example of the effects of receiving two consecutive loans to purchase two vehicles versus receiving one loan allowing for security substitutions.

FIG. 7 shows an example of the effects of receiving two consecutive mortgage loans to purchase two houses versus receiving one mortgage allowing for security substitutions.

### DETAILED DESCRIPTION OF THE PREFERRED EMBODIMENT

In some events, a specific security may no longer serve its initial purpose for a loan. For example, a house may be sold, thereby not allowing the bank to repossess the property in the instance of a default on the loan. In this case, the loan agreement typically stipulates that the borrower must pay the rest of the outstanding debt to the lender (e.g., using money obtained from the sale of the house). However, the sale of an asset by an individual frequently leads to the purchase of a comparable asset by the same individual. The individual must then repay the loan for the first asset and request a second loan for the second asset.

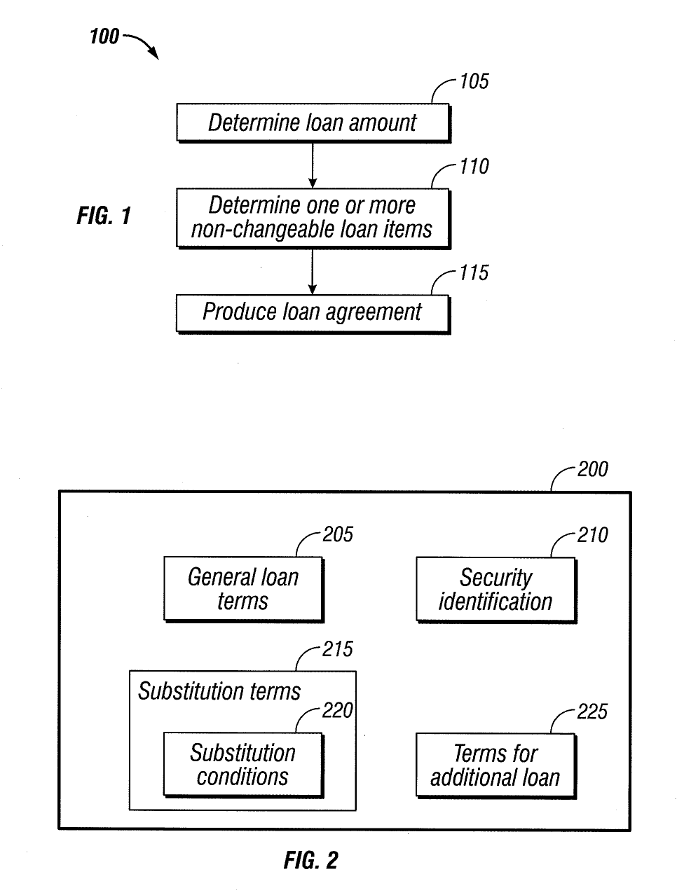

In some embodiments, a method for producing a loan agreement or providing a loan is provided. FIG. 1 shows process 100 for producing a loan agreement. Depending on the embodiment, additional steps may be added, others removed, and the ordering of the steps rearranged.

Process 100 begins at step 105 with the determining of a loan amount to be advanced by a lender to a borrower. This loan amount may be determined on the assumption that the loan will be used to complete a purchase of one or more first assets. In some instances, the loan is used to complete a purchase of one or more first assets. In some embodiments, the loan amount is less than the price and/or value of the one or more first assets, while in other embodiments, the loan amount is substantially equal to or more than the price and/or value of the one or more first assets. The loan amount may be at least partially determined by a plurality of factors, including, for example, the borrower's credit history or credit score, an amount of down payment and/or characteristics of the first asset.

Process 100 continues at step 110 with the determining of one or more non-changeable loan terms. The one or more non-changeable loan terms may include an interest rate and/or a payment period for the repayment of the loan amount. The interest rate may be determined based on, for example, current and/or predicted reference interest rates. The interest rate may be fixed or variable throughout a loan term. The payment period may comprise intervals or time points by which the borrower is expected to repay a payment amount or at least a payment amount to the lender. For example, the borrower may be expected to pay the lender at least $1,000 every month. The one or more non-changeable loan terms may be determined based on the value of the first asset, the loan amount, a credit history or credit score of the borrower, an amount of down payment and/or a term of the loan.

Process 100 continues at step 115 with the producing a loan agreement. The loan agreement may comprise the one or more non-changeable loan terms. The loan agreement may be produced for consideration and/or acceptance of said borrower and/or said lender. In some embodiments, either the borrower or the sender has already considered the loan agreement before its production. The loan agreement may be produced by generating, saving, transmitting, printing and/or displaying a written agreement. The loan agreement may be produced by a computer-implemented method. The loan agreement may be produced by an individual. For example, the lender may write or fill in blanks parts or all of the loan agreement. The loan agreement may be, for example, an auto loan agreement, a mortgage loan agreement, a home loan agreement, a student loan agreement, a credit card agreement and/or a corporate debt agreement.

A computer-implemented method may comprise any or all steps of process 100. For example, a first computer module may be configured to accept information regarding a loan amount to be advanced by a lender to a borrower. A user may input the information using an input device. The information may comprise, for example, the actual loan amount, a requested loan amount, or the price of an asset to be purchased using the money that the borrower obtains from the loan. A second computer module may be configured to determine one or more non-changeable loan terms. For example, the second computer module may determine an interest rate and/or a payment period based on one or more of current interest rates, the credit history of the borrower, the loan amount and the type of asset being purchased with money from the loan. A third computer module may produce the loan agreement. The third computer module may insert specific information into a boilerplate text. The specific information may comprise, for example, the borrower's name and address, the loan amount, and/or the security.

In some embodiments, the loan agreement 200 comprises components as shown in FIG. 2. The loan agreement 200 may comprise general loan terms 205 comprising non-changeable loan terms. The general loan terms 205 may obligate the lender to provide the borrower with the loan amount in exchange for the borrower providing one or more payments to the lender. The one or more payments may comprise a plurality of payments, may be provided at the determined payment periods, and/or may comprise the determined interest rate. The one or more payments may include a minimum payment to be provided during each payment period.

The loan agreement 200 may comprise a security identification 210. The security identification 210 may indicate a security for repayment of said loan amount. The security may comprise one or more first asset. The security may be valued or expected to be valued at an amount that is substantially equal to or more than the loan amount. The loan agreement 200 may specify that the security is repossessed by the lender in the event of the borrower defaulting on the loan.

The loan agreement 200 may include substitution terms 215, which may indicate that one or more second assets may be substituted for one or more first assets identified as the security in the security identification 210. The one or more first assets and/or the one or more second assets may be, for example, a house, a real estate property, an automobile, a motor vehicle, or another property. In some embodiments, the one or more first assets are the same type of property as the one or more second assets, while in others they are not. By substituting the one or more second assets as security for repayment of the loan in place the one or more first assets, the type of the loan may be changed. For example, if a second asset is a car and is substituted for a first asset, which is a house, the loan type may be changed from a mortgage loan to an auto loan.

The substitution terms 215 may indicate conditions in which the lender is obligated to abide by the non-changeable loan terms or on modified loan terms upon the borrower's decision to substitute one or more second assets as security for repayment of the loan in place of one or more first assets identified as the security in the security identification 210. The conditions may include a borrower risk variable. The borrower risk variable may include one or more of a credit score, a FICO score, a level of financial documentation, a type of financial documentation, an income-to-expense ratio, a predicted income-to-expense ratio, a type of loan, an income, a predicted income, and an age. The conditions may include an expected security value variable, which may comprise one or more of the value of the one or more second assets, the demand of the one or more second assets, the supply of the one or more second assets, and the liquidity of the one or more second assets. The conditions may include an outstanding debt value. For example, the conditions may include that the current or predicted value of the one or more second assets must be larger than the outstanding debt.

In some instances, the one or more second securities can be substituted for all of the one or more first assets, while in other instances, the one or more second securities can be substituted for a portion of the one or more first assets. The conditions may include that the one or more second assets be a similar type of asset as the one or more first assets.

The substitution terms 215 may indicate modification conditions in which the lender is obligated to abide by modified loan terms upon the borrower's decision to substitute a second asset as security for repayment of the loan amount in place of the first asset. The modified conditions may include a decrease in a borrower risk variable as compared to a previous borrower risk variable, an increase in the value or expected value of the second asset as compared to the previous or current value or expected value of the first asset, and/or a decrease in a borrower risk versus expected security value variable. The modified loan terms may include the initial loan terms modified to be more beneficial to the borrower. For example, the loan terms may be modified to include one or more of a lower interest rate as compared to that of said initial loan terms, a lower coupon rate as compared to that of said initial loan terms, and a longer grace period, as compared to that of said initial loan terms.

The modified conditions may include an increase in a borrower risk variable as compared to a previous borrower risk variable, a decrease in the value or expected value of the second asset as compared to the previous or current value or expected value of the first asset, and/or an increase in a borrower risk versus expected security value variable. The modified loan terms may include the initial loan terms modified to be more punitive to the borrower. For example, the loan terms may be modified to include one or more of a higher interest rate as compared to that of said initial loan terms, a higher coupon rate as compared to that of said initial loan terms, and a shorter grace period, as compared to that of said initial loan terms.

The substitution terms 215 may indicate constant conditions in which the lender is obligated to abide by the initial loan terms upon the borrower's decision to substitute a second asset as security for repayment of the loan amount in place of the first asset. The constant conditions may include substantially no change in a borrower risk variable as compared to a previous borrower risk variable, the value or expected value of the second asset as compared to the previous or current value or expected value of the first asset, and/or a borrower risk versus expected security value variable.

In some instances, the security identification 210 comprises the substitution terms 215. For example, the security identification 210 may identify that one or more of a plurality of assets may be used as a security. The security identification 210 may identify a group of assets or characteristics of assets that would be suitable for a security. When more the security identification 210 indicates a plurality of acceptable assets or groups of assets acceptable as a security, the security identification 210 may indicate that one of the plurality of acceptable assets or groups of assets may be substituted for another of the plurality during the loan term.

The substitution terms 215 may indicate substitution conditions 220 in which the lender is obligated to aide by the loan agreement terms 205 upon the borrower's decision to substitute a second asset as security for repayment of the loan amount in place of the first asset. The substitution conditions 220 may relate to one or more of the value of the original security, the value of the new security, the borrower's credit, the outstanding loan, and the loan term. The substitution conditions 220 may include that the current or predicted value of the second asset must be larger than the outstanding debt associated with the loan, larger than the loan amount, larger than the current and/or predicted value of the first asset. The substitution conditions 220 may include that the depreciation of the new security does not exceed a depreciation schedule. This may ensure that the value of the new security continues to exceed a principal balance. The substitution conditions 220 may include that minimum maintenance needs and appraisals must be undertaken to calculate the value of a security.

The substitution conditions 220 may include that the level of subordination does not change (e.g., a first lien mortgage continues to be a first lien mortgage on substitute securities.) The substitution conditions 220 may include that the borrower's credit exceed a threshold value. The borrower's credit may comprise credit associated with the payment history of the loan amount, a credit score (e.g., FICO score) and/or a general history. For example, the substitution conditions 220 may include that the borrower must have made all previous payments of the loan on time and for at least the amount agreed upon. The substitution conditions 220 may include that the borrower's predicted income exceed a threshold value and/or that the borrower's predicted expenses fall below a threshold value. The substitution conditions 220 may include that the borrower's predicted income relative to the borrower's predicted expenses exceed a threshold value. In some embodiments, the substitution conditions 220 may include that the second asset be a similar type of asset as the first asset. For example, if the first asset is a house, the second asset may be required to be a house. In some embodiments, the substitution conditions 220 may include that the asset and/or the borrower remain within a particular location. For example, the conditions may stipulate that the second asset be within the same state. The substitution conditions 220 may stipulate that the second asset is not a security for another loan.

The loan agreement 200 may further indicate additional conditions in which upon the borrower's decision to substitute one or more second assets as security for repayment of the loan amount instead of one or more first assets, the lender is obligated to provide the borrower with an additional loan amount. The additional loan amount may be subject to terms 225 for the additional loan. The terms 225 for the additional loan may include the general loan terms 205 or may be either more beneficial or more punitive to the borrower. The additional loan amount may be an amount to complete the purchase of the one or more second assets. The additional loan amount may comprise an amount less than or equal to a threshold loan amount. The additional loan amount may be provided by the lender in exchange for the borrower providing periodic payments. The periodic payments may be at the determined interest rate and/or at the determined payment periods.

In some embodiments, an initial payment amount is determined. The general loan terms 205 may further obligate the borrower to provide the initial payment amount to the lender. The loan agreement 200 may further indicate that, when substitution conditions 220 are met, the borrower is not obligated to provide additional payments over the periodic payments upon the borrower's decision to substitute one or more second assets as security for repayment of the loan amount instead of one or more first assets. Alternatively, the loan agreement 200 may further indicate that, when substitution conditions 220 are met, the borrower is obligated to provide additional payments over the periodic payments upon the borrower's decision to substitute the second asset as security for repayment of the loan amount instead of the first asset. The additional payments may comprise a one-time payment or a plurality of payments. The additional payments may include a service fee.

The loan agreement 200 may comprise a mortgage loan agreement, a home loan agreement, a title loan agreement, a student loan agreement, a credit card agreement, a corporate debt agreement, a business loan agreement and/or a loan agreement for multiple entities (e.g., future products or a loan for a combination of a motor vehicle and property). The one or more first assets may comprise a first real estate property, a house, and/or a motor vehicle. The one or more second assets may comprise a second real estate property, a house, and/or a motor vehicle.

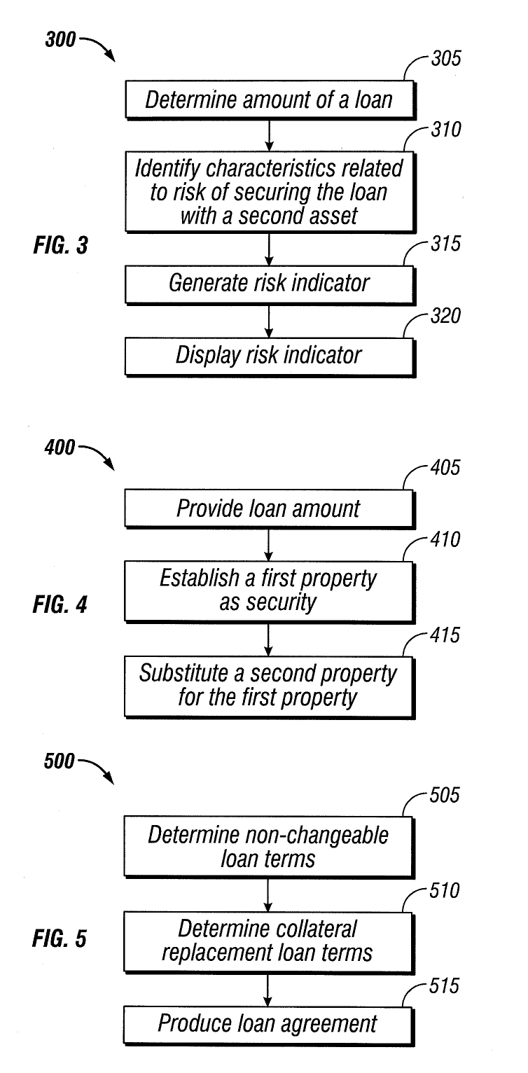

FIG. 3 shows a process 300 for indicating risk of securing a loan with a substituted asset. Depending on the embodiment, additional steps may be added, others removed, and the ordering of the steps rearranged.

At step 305, an amount of a loan is determined. The amount of the loan may be at least partially secured by one or more first assets. The amount of the loan may comprise an initial or a total amount of the loan. The amount of the loan may comprise a total amount of the loan in addition to an interest. The amount of the loan may comprise an outstanding debt associated with the loan. The amount of the loan may be determined by accepting a first input. For example, a user may input the amount of the loan through any acceptable input device (e.g., a keyboard or computer mouse).

At step 310, a characteristic related to the risk of securing the loan with a second asset is identified. The second asset may comprise a plurality of second assets. In some embodiments, the risk of securing comprises the risk of partially securing, indicating that the second asset is not the only asset acting as a security for the loan. The characteristic may comprise the value or predicted value of the second asset and/or the value or predicted value of at least one of the one or more first assets. The characteristic may comprise a characteristic about the borrower, such as, for example, one or more of a variable related to a credit score, a FICO score, a level of financial documentation, a type of financial documentation, an income-to-expense ratio, a predicted income-to-expense ratio, a type of loan, an income, a predicted income, and an age. The characteristic may be identified by accepting a second input related to the risk of securing the loan with the second asset. For example, a user may input the second input through any acceptable input device (e.g., a keyboard or computer mouse). The second input may be obtained through a computer network or from accessing stored medium.

At step 315, at least one indicator of risk of securing the loan with the second asset is generated. The indicator of risk may, for example, indicate whether the value or predicted value of the second asset is above a threshold and/or above the value or predicted value of at least one of the one or more first assets. The threshold may comprise a pre-determined amount, the outstanding debt related to the loan and/or the initial amount of the loan. The indicator may comprise an indication as to whether the second asset is an acceptable security and/or whether the second asset is an acceptable substitution for the first asset. The indicator may comprise a number, text and/or a binary indication.

The generating the at least one indicator may comprise comparing the value or predicted value of the second asset to a threshold, the outstanding debt related to the loan, the initial amount of the loan, and/or the value or predicted value of at least one of the one or more assets. The generating the at least one indicator may comprise comparing a characteristic about the borrower to a previous characteristic about the borrower. For example, if the borrower's credit score improved or if the borrower established a strong payment history, the risk of securing the loan with the second asset may be lowered than if the borrower's credit score did not improve or if the borrower did not establish a strong payment history.

At step 320, the at least one indicator of risk is output. In some embodiments, the at least one indicator of risk is displayed. For example, the at least one indicator of risk may be displayed on a computer screen. In another embodiment, the at least one indicator is printed and/or transmitted.

In some embodiments, a computer program includes instructions for process steps from process 300 stored on a computer-readable medium. A computer-implemented method may comprise any or all steps of process 300. For example, a user may input an amount of a loan through an input device. A user may input a characteristic related to the risk of securing the loan with a second asset through an input device. A microprocessor may be configured to generate at least one indicator of risk of securing the loan with the second asset. The at least one indicator of risk may be output through an output device.

In some embodiments, a method of providing a mortgage loan is provided. FIG. 4 shows one process 400 for providing a mortgage loan. Depending on the embodiment, additional steps may be added, others removed, and the ordering of the steps rearranged.

Process 400 begins at step 405 with providing a loan amount to borrow in exchange for the agreement of repayment of the loan amount by the borrower to the loan provider. The repayment may additionally include the payment of interest to the loan provider. The repayment may comprise providing periodic payments of specified amounts, and the periodic payments may occur at specified times.

Process 400 continues at step 410 with securing an interest in a first property as security for the repayment. The first property may comprise, for example, a house. The first property may be a property to be at least partially or wholly purchased by money from the loan. The first property value or predicted value may exceed or match that of the loan amount.

Process 400 continues at step 415 with substituting a second property for the first property as the security under at least some specified conditions. The conditions may comprise any condition stated herein, such as the value or predicted value of the second property must exceed that of the first property. The substitution of the second property may occur some time period after the other steps of the process.

In some embodiments, the borrower is allowed to sell a first property before a loan has been repaid. In some embodiments, a loan agreement indicates a specific time period following the sale of a first asset by which the borrower must have either repaid the outstanding loan amount to a loan provider or have obtained and/or been approved for a substitute asset to function as a security.

In some embodiments, one or more loan terms may be changed upon substitution of the second property for the first property as security. For example, the interest rate or payment period may change. The one or more loan terms may favorably change if the risk associated with the second property as security is smaller for the loan provider than the risk associated with the first property as security.

A computer-implemented method may comprise any or all steps of process 400. For example, a first computer module may be configured to accept information regarding a loan amount to be advanced by a lender to a borrower. A user may input the information using an input device. The information may comprise, for example, the actual loan amount, a requested loan amount, or the price of an asset to be purchased using the money that the borrower obtains from the loan. A second computer module may be configured to determine a first property as security for the repayment. A user may input the first property using an input device, and/or the user may input characteristics (e.g., location or value) of the first property using an input device. A third computer module may be configured to identify conditions for which a second property can be substituted for the first property. For example, the third computer module may accept input regarding a second property and determine based on a risk assessment whether such a substitution can occur. The third computer module may be pre-configured with specified conditions (such as minimizing or maintaining risk).

In some embodiments, a method of producing a loan agreement defining loan obligations between a borrower and a lender is provided. FIG. 5 shows one process 500 for producing a loan agreement. Depending on the embodiment, additional steps may be added, others removed, and the ordering of the steps rearranged.

Process 500 begins at step 505 with determining first loan terms comprising loan characteristics that are not changeable during the loan term. The first loan terms may comprise, for example, an interest rate, a payment period and/or a minimum payment. This first loan terms may include a defined interest rate, which may be either fixed or variable.

Process 500 continues at step 510 with determining second loan terms including collateral characteristics sufficient for at least partially replacing a collateral. The second loan terms may, for example, comprise an initial collateral and/or possible substitute collateral. The second loan terms may include the identities, characteristics, values and/or locations of acceptable collateral for the loan.

Process 500 continues at step 515 with producing a loan agreement. The loan agreement may be considered by the borrower and/or lender. The loan agreement may comprise the first and second loan terms. The loan agreement may comprise third loan terms that are changeable upon the at least partially replacing the collateral. For example, the third loan terms may indicate that the interest rate can change depending upon the relative values of the initial and substitute collaterals.

A computer-implemented method may comprise any or all steps of process 500. For example, a first computer module may be configured to determine first loan terms. The first loan terms may be input by a user or may be determined by the module based on other input from a user. For example, the user may input a down-payment and requested loan amount, and the first computer module may identify an interest rate and a payment period. A second computer module may be configured to determine second loan terms including collateral characteristics sufficient for at least partially replacing a collateral. The second computer module may be configured to accept user input regarding, for example, the identity, value or predicted value an initial collateral. The second computer module may determine the second loan terms by minimizing or maintaining a risk associated with the loan. A third computer module may produce a loan agreement. The loan agreement may be displayed, saved, printed or transmitted by the third computer module.

In some embodiments, a computer system is provided to perform a process described herein. The computer system may include a microprocessor. The microprocessor may be any conventional general purpose single- or multi-chip microprocessor such as a Pentium® processor, Pentium II® processor, Pentium III® processor, Pentium IV® processor, Pentium® Pro processor, a 8051 processor, a MIPS® processor, a Power PC® processor, or an ALPHA® processor. In addition, the microprocessor may be any conventional special purpose microprocessor such as a digital signal processor. The microprocessor may have conventional address lines, conventional data lines, and one or more conventional control lines. The microprocessor may be configured to perform any process disclosed herein.

The computer system may comprise a local area network (LAN). One example of the LAN may be a corporate computing network, including access to the Internet, to which computers and computing devices comprising the data care system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware, and Banyon VINES.

The computer system may include a memory. Memory refers to electronic circuitry that allows information, typically computer data, to be stored and retrieved. Memory can refer to external devices or systems, for example, disk drives or tape drives. Memory can also refer to fast semiconductor storage (chips), for example, Random Access Memory (RAM) or various forms of Read Only Memory (ROM), that are directly connected to the processor. Other types of memory include bubble memory and core memory.

The computer system may include one or more input devices. For example, the input device may be a keyboard, rollerball, pen and stylus, mouse, or voice recognition system. The input device may also be a touch screen associated with an output device. A user may respond to prompts on the display by touching the screen. Textual or graphic information may be entered by the user through the input device.

The computer system may be comprised of various modules. A module may be configured to perform a process step described herein. As can be appreciated by one of ordinary skill in the art, each of the modules comprises various sub-routines, procedures, definitional statements, and macros. Each of the modules are typically separately compiled and linked into a single executable program. The process steps that are undergone by each of the modules may be arbitrarily redistributed to one of the other modules, combined together in a single module, or made available in a shareable dynamic link library. Further each of the modules could be implemented in hardware.

The computer system may comprise one or more output devices. The output device may include a display and/or screen. The output device may include a printer and/or a transmission component, by which the computer system may transmit data to another computer, a server or a network.

In some embodiments, an interactive webpage performs a process described herein. The webpage may, for example, display text, graphics or symbols prompting the user to input information associated with a loan and/or a security. A processor may determine a risk factor associated with substituting a second asset for a first asset as security and display the risk factor on the webpage. The web pages are virtual documents that each have embedded links which link portions of the virtual pages to other virtual pages and other data. A user can traverse the virtual pages and download data by selecting with a mouse or other input device a predetermined portion of the virtual page.

In some embodiments, a computer program may include instructions for process steps from any process disclosed herein may be stored on a computer-readable medium.

Embodiments herein may be characterized by a plurality of advantages. In some instances, embodiments can be advantageous to the borrower. For example, currently, sale of a first asset can cause a borrower to repay a first loan and request a second loan. Interest rates may have changed from the time the initial loan was received to the time the second loan was requested. Therefore, embodiments herein can provide predictable interest rates for the borrower.

Fees associated with a second loan may be reduced or avoided. For example, upfront and processing fees are frequently associated with loans. Embodiments herein can reduce the number of loans that an individual must receive thereby reducing these fees.

Paperwork and/or time associated with obtaining a second loan may be reduced or avoided. Embodiments herein can reduce the number of loans that an individual must receive thereby reducing time researching loans, applying for loans, accepting loans and paperwork associated therewith.

The borrower can also continue to refinance, for example, as mortgage rates decline, which may secure a steadily lower mortgage rate as interest rates decline. These lower rates may then be maintained throughout the life of the loan.

The financial institution or loan provider may benefit as well. The average life of the loan may increase. Even if a borrower no longer owns a security of the loan, the borrower may substitute another security based upon a method described herein. Therefore, the life of the loan can extend beyond the time period that the borrower owns an initial security. This can, in turn, improve the value of the loan (e.g., capitalized servicing like Mortgage Servicing Rights). Improved values can translate into larger gains and improve the earnings of the financial institution or provider.

A provider could also improve the probability of provider loans to a borrower who has relocated. A borrower who relocated may be more likely to continue an existing loan with a loan provider if a security can be substituted (e.g., if a new house can be used as a new security for a mortgage loan). Additionally, because the borrower may wish to reduce paperwork and time, future loans may also be sought from the initial provider.

Because embodiments described herein offer advantages to the borrower, borrowers may seek out a financial institution or loan provider who offers loans as described herein. The additional borrowers could profit additional profits.

Embodiments described herein may reduce the probability of loan refinancing. Refinancing may be predicted to occur only when rates go below the day the initial loan is received. For example, if the interest rate is 5.25% initially, rise to 10% then fall to 7%. If an individual receives two loans during this time period (one at 5.25% interest, the other at 10% interest), he may refinance the second loan. Meanwhile, if only one loan is received (at 5.25% interest), he will not refinance at either subsequent interest rate.

Embodiments described herein may offer an incentive for borrowers to request long-term loans beyond an expected time period of owning an asset. This may provide, for example, an incentive to move from hybrid Adjustable Rate Mortgages (e.g. Fixed APR for 1, 2, 5, 10 years and Adjustable Rate Mortgage there after) to fixed products (e.g. 30 years fixed mortgage). The borrower may have an increased incentive to avoid predatory lending companies that provide false incentives to opt for adjustable rate mortgages. This may provide improved predictability for banks that have a mortgage portfolio and can lower their risk profile and hence capital intensity.

Embodiments described herein may maintain or reduce a loan provider's credit risk. The credit risk associated with a loan may include a borrower's ability to meet obligations and the value of the security staying higher than the value of the outstanding amount due to the loan provider. Embodiments herein may provide low risk associated with a loan by imposing specific conditions on securities and/or substitute securities.

### EXAMPLES

### Example 1

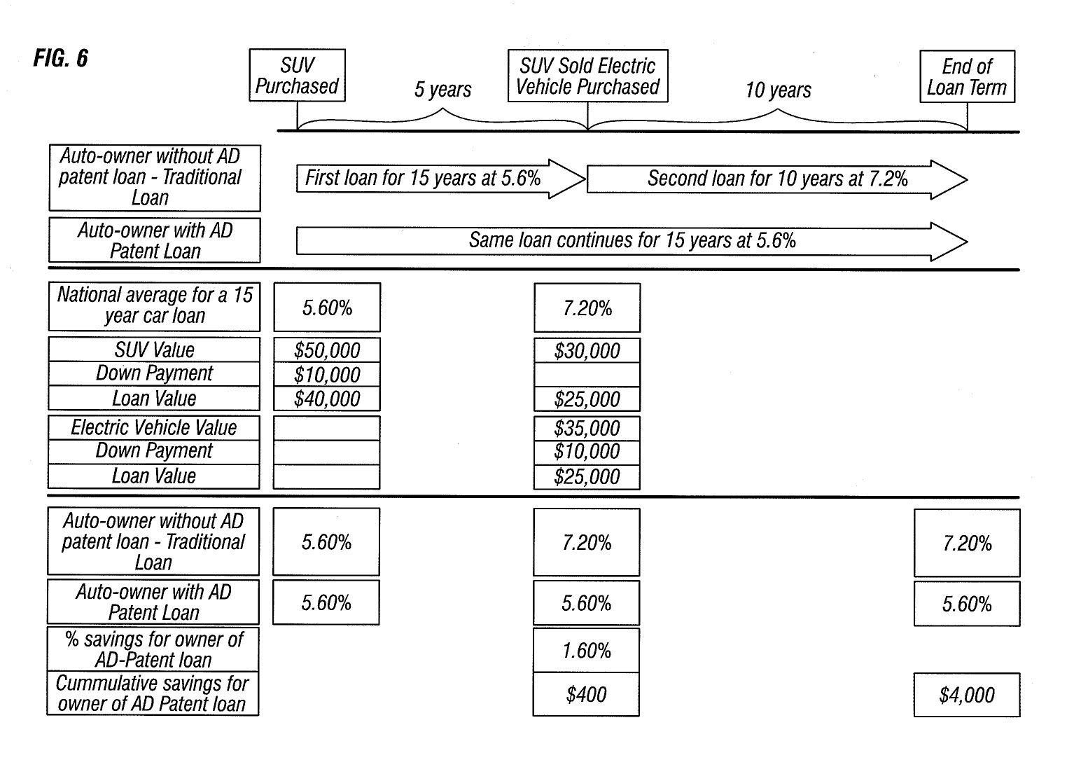

FIG. 6 shows an example of the effects of receiving two consecutive loans to purchase two vehicles versus receiving one loan allowing for security substitutions. A first and a second borrower request a loan to purchase a Sports Utility Vehicle (SUV). The SUV is approximately $50,000 but both borrowers pay a $10,000 down payment, so the requested loan amount is $40,000 for each borrower. The first borrower receives a 15-year loan with a fixed interest rate of 5.6%. The SUV to be purchased acts as the security for the loan, and the first borrower is not allowed to substitute another security for the SUV. The second borrower also receives a 15-year loan with a fixed interest rate of 5.6%. However, while the SUV acts as an initial security, the second borrower is allowed to substitute a second security for the SUV if the second security is of similar or higher value than the SUV.

Five years into the loan, both borrowers sell the SUVs and purchase an electric vehicle. The electric vehicle is approximately $35,000. At this time, the SUV is valued at $30,000 and the outstanding loan amount is $25,000.

The first borrower is required to pay off his loan and apply for a second loan. The first borrower pays a $10,000 down payment and receives a second loan that is a 10-year loan with a fixed interest rate of 7.2%. Meanwhile, the second borrower can continue with the first loan, as the value of the electric vehicle is greater than the outstanding loan amount.

By the end of the initial 15-year term, the first borrower spends $4,000 more than the second borrower to pay off both loans.

### Example 2

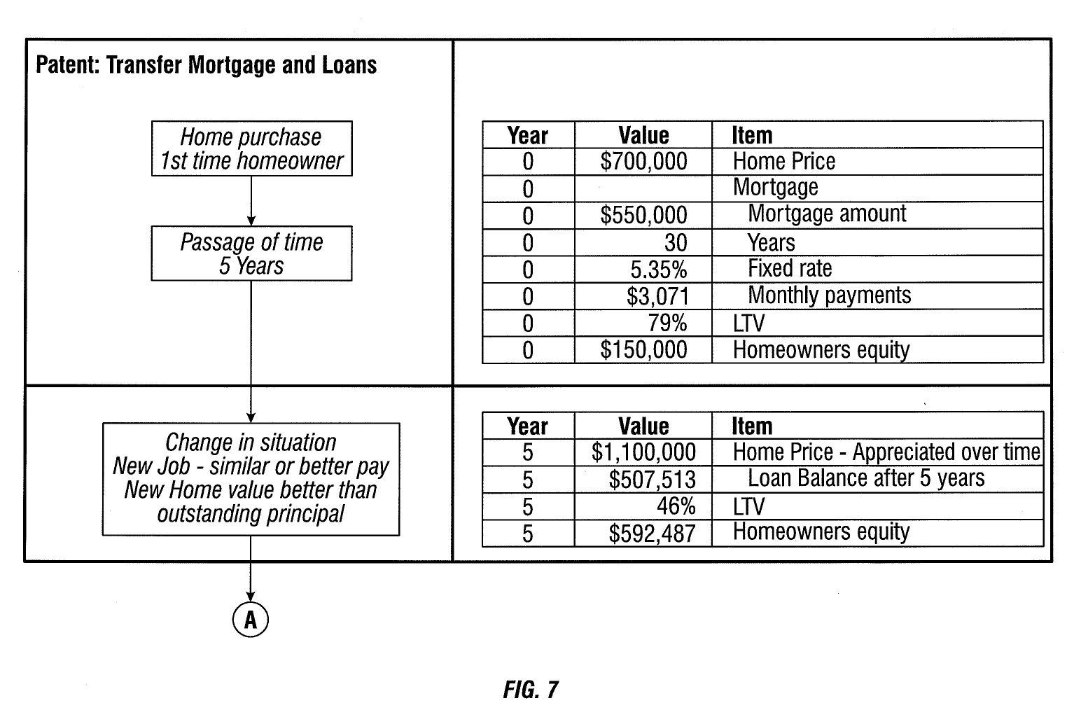

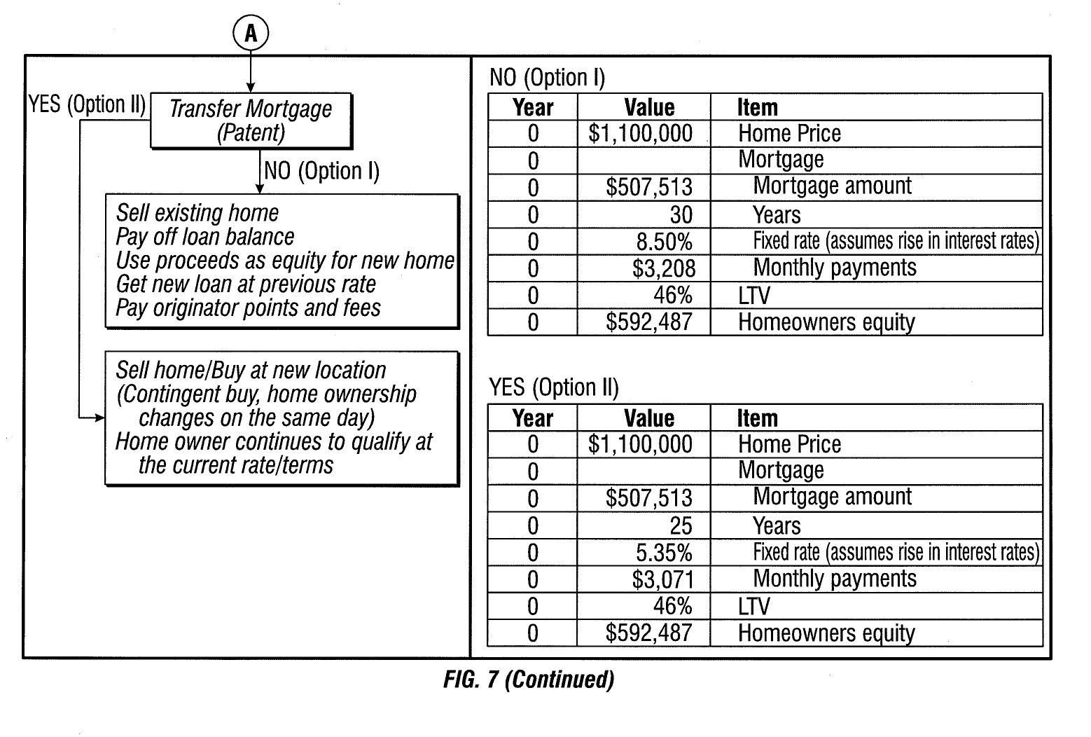

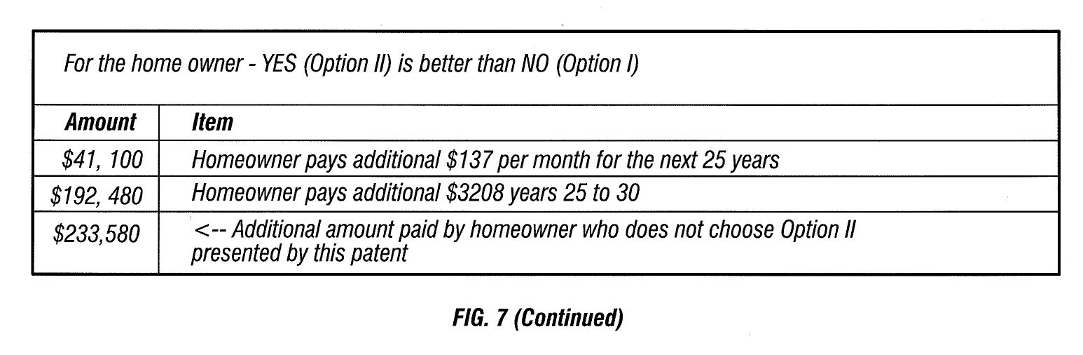

FIG. 7 shows an example of the effects of receiving two consecutive mortgage loans to purchase two houses versus receiving one mortgage allowing for security substitutions. A borrower compares two loans in order to purchase his first home. The first loan requires that the first home be used as security and does not allow for another asset to be subsequently substituted. The second loan uses the first home as security and does allow for a second asset of equal or higher value of the outstanding debt to be substituted for the first home as security, provided that the second asset is owned before or on the same day that the first home is sold.

The borrower's first home is $700,000. The requested mortgage loan amount is $550,000 and will be paid off for 30 years at a fixed interest rate of 5.35%. The monthly payments are $3,071. The LTV is initially 79% and the homeowner's equity is initially $150,000.

The borrower predicts a change in his situation five years after the loan. He predicts that he will have a new job with similar or better pay and a new home valued better than an outstanding principle on the loan. At that time, the first home has appreciated to a value of $1,100,000. The outstanding loan balance is $507,513, the LTV is 46% and the homeowner's equity is $592,487.

The borrower predicts that he will buy another house valued at $ 1,100,000 or higher. Therefore, he will not be able to pay the loan off after the sale of his first house. The first loan does not allow a substitution of securities. Thus, the borrower will sell his first home, pay off the $507,513 of outstanding balance, use the proceeds as equity for a new home, get a loan at a prevailing interest rate predicted to be 6.5% and pay origination points and fees. In this instance, the buyer predicts 30 additional years of the mortgage, with $3,208 monthly payments.

The second loan does allow a substitution of securities. Thus, the borrower will sell his first home, use all of the money to purchase the other house and continue the monthly payments of $3,071 for the remaining 25 years of the mortgage.

Due to the higher interest rates, the first loan is associated with an additional $137 a month during the 25 years following the purchase of the other house, which cumulates to $41,100. Because the first loan is longer than the second loan, the first loan is also associated with an additional $192,480 during the 25th-30th years following the purchase of the other house. Therefore, the borrower chooses the second loan and saves $233,580.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A method of producing a loan agreement defining loan obligations between a borrower and a lender, said method comprising:
determining a loan amount to be advanced by the lender to the borrower;
determining an interest rate and payment period for the repayment of the loan amount; and
producing a loan agreement for consideration of said borrower and said lender,
wherein said loan agreement comprises initial loan terms that obligates said lender to provide said borrower with said loan amount in exchange for said borrower providing periodic payments at said payment periods and comprising said interest rate to said lender;
wherein said loan agreement identifies a security comprising a first asset for repayment of said loan amount, and
wherein said loan agreement indicates conditions in which said lender is obligated to abide by said initial loan terms or modified loan terms upon the borrower's decision to substitute a second asset as security for repayment of said loan amount in place of said first asset.

2. The method of claim 1, wherein said conditions comprise a borrower risk variable.

3. The method of claim 1, wherein said conditions comprise an expected security value variable.

4. The method of claim 1, wherein said conditions comprise an outstanding debt value.

5. The method of claim 1, wherein said loan agreement indicates conditions in which said lender is obligated to abide by modified loan terms upon the borrower's decision to substitute a second asset as security for repayment of said loan amount in place of said first asset,
wherein said conditions comprise a decrease in a borrower risk versus expected security value variable, and
wherein said modified loan terms comprise said initial loan terms modified to be more beneficial to the borrower.

6. The method of claim 5, wherein said modified loan terms comprise one or more of a lower interest rate as compared to that of said initial loan terms, a lower coupon rate as compared to that of said initial loan terms, and a longer grace period as compared to that of said initial loan terms.

7. The method of claim 1, wherein said loan agreement indicates conditions in which said lender is obligated to abide by modified loan terms upon the borrower's decision to substitute a second asset as security for repayment of said loan amount in place of said first asset,
wherein said conditions comprise an increase in a borrower risk versus expected security value variable, and
wherein said modified loan agreement terms comprise said initial loan terms modified to be punitive to the borrower.

8. The method of claim 1, wherein said loan agreement indicates conditions in which said lender is obligated to abide by said initial loan terms upon the borrower's decision to substitute a second asset as security for repayment of said loan amount in place of said first asset, and
wherein said conditions comprise substantially no change or a decrease in a borrower risk versus expected security value variable.

9. The method of claim 1, wherein said loan agreement comprises one or more of an auto loan agreement, a home loan agreement, a student loan agreement, a credit card agreement, and a corporate debt agreement.

10. The method of claim 1, wherein said first asset comprises a first motor vehicle and said second asset comprises a second motor vehicle.

11. The method of claim 1, wherein said loan agreement comprises one or more loan types selected from an auto loan agreement, a home loan agreement, a student loan agreement, a credit card agreement, and a corporate debt agreement.

12. The method of claim 1, wherein said conditions comprise that the current or predicted value of the second asset must be larger than the outstanding debt associated with said loan.

13. The method of claim 1, wherein said conditions comprise that said second asset be a similar type of asset as said first asset.

14. The method of claim 1, wherein said loan agreement further indicates additional conditions and additional loan terms for which said lender is obligated to provide said borrower with an additional loan amount.

15. The method of claim 14, wherein said additional loan terms comprise said initial loan terms.

16. A computer program, said program including instructions stored on a computer readable medium for:
accepting a first input of an amount of a loan secured by a first asset;
accepting a second input related to the risk of securing the loan with a second asset;
generating at least one indicator of risk of securing the loan with the second asset for the loan amount; and
outputting the at least one indicator of risk.

17. The computer program of claim 16, wherein said second input comprise one or more variables related to a current value of the second asset, a predicted value of the second asset, a credit score, a FICO score, a level of financial documentation, a type of financial documentation, an income-to-expense ratio, a predicted income-to-expense ratio, a type of loan, an income, a predicted income, and an age.

18. The computer program of claim 16, wherein the generating at least one indicator comprises determining whether the current or predicted value of the second asset exceeds an outstanding loan amount.

19. The computer program of claim 16, wherein said first input comprises one or both of an initial loan amount and an outstanding loan amount.

20. A method for providing a mortgage loan comprising:
providing a loan amount to a borrower in exchange for the agreement of repayment of the loan amount and an interest by the borrower to the loan provider, wherein the repayment comprises providing periodic payments of specified amounts and at specified times;
securing an interest in a first property as security for the repayment; and
substituting a second property for the first property as the security under at least some specified conditions.

21. The method of claim 20, further comprising allowing the borrower to sell the first property before the borrower has repaid the loan amount and the interest under the at least some specified conditions.

22. The method of claim 20, further comprising changing one or more loan terms upon substitution of said second property for said first property as the security.

23. A method for producing a loan agreement defining loan obligations between a borrower and a lender, said method comprising:
determining first loan terms comprising loan characteristics that are not changeable during the loan term;
determining second loan terms comprising collateral characteristics sufficient for at least partially replacing a collateral; and
producing a loan agreement for consideration of said borrower and said lender comprising said first loan terms and said second loan terms.

24. The method of claim 23, wherein said first loan terms comprise one or more of an interest rate, a payment period and an initial collateral.

25. The method of claim 23, further comprising determining third loan terms comprising loan characteristics that are changeable upon the at least partially replacing a collateral.
